(19) United States
(12) Patent Application Publication
(10) Pub. No.: US 2004/0167655 A1
(43) Pub. Date: Aug. 26, 2004

(54) Optimal model predictive control of overlay implemented in a ASIC fab

(76) Inventors: Scott Middlebrooks, Sandy, OR (US); Paul Szasz, Gresham, OR (US)

Correspondence Address: LSI LOGIC CORPORATION, 1621 BARBER LANE, MS: D-106 LEGAL, MILPITAS, CA, 95035, US

(21) Appl. No.: 10/441,215

(22) Filed: May 19, 2003

Related U.S. Application Data
(60) Provisional application No. 60/449,559, filed on Feb. 22, 2003.

(51) Int. Cl. G06F 7/60

(52) U.S. Cl. 700/121

(57) ABSTRACT

A method and model-predictive controller that takes raw overlay registration data from a metrology tool, such as the KLA-5200 metrology tool, and estimates process disturbances. Once these disturbances are estimated, the controller regulates them to zero, resulting in precise control of overlay. The controller includes a state estimator which is configured to estimate the following system states: wafer x-translation, wafer y-translation, wafer scale in x, wafer scale in y, wafer rotation, wafer non-orthogonality, reticle magnification, asymmetric magnification, reticle rotation, asymmetric reticle rotation. The controller includes a regulator which is configured to regulate the system states to desired targets.

### RELATED APPLICATION (PRIORITY CLAIM)

This application claims the benefit of U.S. Provisional Application Serial No. 60/449,559, filed Feb. 21, 2003.

### BACKGROUND

The present invention generally relates to models, apparatus and methods relating to ASIC fabrication, and more specifically relates to a model, model-predictive controller and method for precisely controlling overlay in ASIC fabrication.

A semiconductor device is fabricated by successive deposition and etching of many layers. In order for the device to work, each layer must align exactly with the previous layers. This is known as overlay control.

There are commercial products currently available from such vendors as New Vision Systems and Yield Dynamics that attempt to regulate overlay errors. These controllers are mathematically sub-optimal and are basic Proportional-gain controllers. In addition to being unstable, these P-type controllers will never regulate the overlay errors to zero. Manual control is the alternative.

### OBJECTS AND SUMMARY

An object of an embodiment of the present invention is to provide a controller which is stable and mathematically optimal.

Another object of an embodiment of the present invention is to integrate fundamental models and metrology sensors with state-of-the-art estimation and model-predictive control techniques in order to drive overlay registration errors for each unique tool-device-layer-reticle combination to zero.

Yet another object of an embodiment of the present invention is to employ a process model to estimate process disturbances and employ a state disturbance model to remove steady-state offset due to the mismatch between the process model prediction and reality.

Briefly, and in accordance with at least one of the foregoing objects, an embodiment of the present invention provides a model-predictive controller that takes raw overlay registration data from a metrology tool, such as the KLA-5200 metrology tool, and estimates process disturbances. Once these disturbances are estimated, the controller regulates them to zero, resulting in precise control of overlay.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 illustrates a model-predictive controller which is in accordance with an embodiment of the present invention;

FIG. 2 illustrates in more detail the estimator shown in FIG. 1;

FIG. 3 illustrates misalignment vectors which are measured by the overlay metrology tool shown in FIG. 1;

FIG. 4 provides a graph which illustrates the controller of FIG. 1 rejecting disturbance in grid translation, Tₓ;

FIG. 5 provides a graph which illustrates the controller of FIG. 1 rejecting disturbance in grid translation, T_{y};

FIG. 6 provides a graph which illustrates the controller of FIG. 1 rejecting disturbance in reticle magnification, Mᵣ;

FIG. 7 provides a graph which illustrates the controller of FIG. 1 rejecting disturbance in reticle asymmetric magnification, Mₐ;

FIG. 8 provides a graph which illustrates resulting x-misalignment errors, Δe^{x}, measured by the overlay metrology tool shown in FIG. 1, wherein the controller was turned on at sample number 21;

FIG. 9 provides a graph which illustrates resulting y-misalignment errors, Δe^{y}, measured by the overlay metrology tool shown in FIG. 1, wherein the controller was turned on at sample number 21;

FIG. 10 illustrates measured and modeled overlay errors for a sample that was processed with the controller of FIG. 1 turned off;

FIG. 11 illustrates measured and modeled overlay errors for a sample that was processed with the controller of FIG. 1 turned on;

FIG. 12 provides a tabulation of process capabilities for the misalignment vectors Δe^{x} and Δe^{y} calculated over a month when the controller shown in FIG. 1 was turned off and over a month when the controller was turned on, wherein Cₚₖ is calculated for each critical layer and includes measurements of all device codes and all photolithography steppers; and

FIG. 13 provides a block diagram of a method which is in accordance with an embodiment of the present invention.

### DESCRIPTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

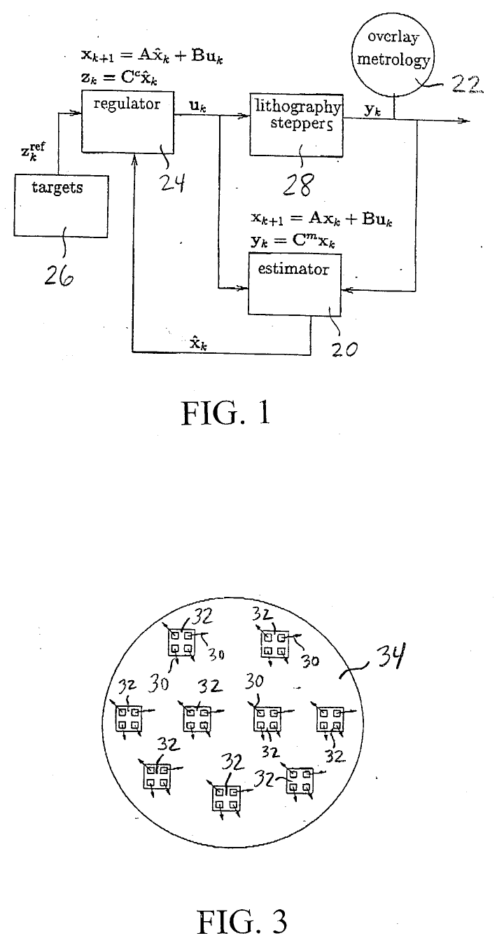

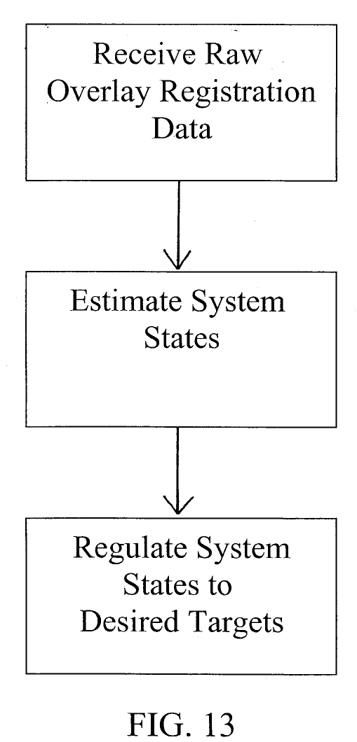

As device sizes continue to shrink, the need for precise control of overlay misalignment errors has become a necessity. An embodiment of the present invention integrates fundamental models and metrology sensors with state-of-the-art estimation and model-predictive control techniques in order to drive overlay registration errors for each unique tool-device-layer-reticle combination to zero. FIG. 1 illustrates a controller which is in accordance with an embodiment of the present invention. The controller is stable, mathematically optimal, and is very effective in rejecting process disturbances. As shown in FIG. 13, the controller receives output measurements (i.e., raw overlay registration data), estimates system states, and regulates inputs (i.e., system states) to desired targets, thereby controlling overlay.

Specifically, as shown in FIG. 1, the controller includes a state estimator 20 which is configured to estimate process disturbances or system states from raw overlay registration data received from a metrology tool 22, such as a KLA-5200 metrology tool. The state estimator 20 systematically maps process corrections to measured outputs. The controller also includes a regulator 24 which is configured to regulate the system states to desired targets 26 by controlling inputs to lithography steppers 28. The states which are estimated and the inputs which are subsequently controlled based on the estimations preferably include the following: wafer x-translation, wafer y-translation, wafer scale in x, wafer scale in y, wafer rotation, wafer non-orthogonality, reticle magnification, asymmetric magnification, reticle rotation and asymmetric reticle rotation. The states which are estimated may be represented as x, a 10×1 vector. Likewise, the inputs which are controlled may be represented as u, a 10×1 vector. The raw overlay registration data which is received from the metrology tool 22 may be represented as y, a 72×1 vector.

The model-predictive controller shown in FIG. 1 is very effective in rejecting disturbances in the overlay process, such as tool drift and model mismatch. Preferably, the regulator 24 provides that all overlay errors are driven to zero +/− the measurement variance of the metrology tool 22. This level of control is achieved for every tool-device-layer-reticle combination. Hence, the controller is configured to provide that the state estimator 20 estimates process disturbances, and once these disturbances are estimated, the regulator 24 regulates them to zero, resulting in precise control of overlay.

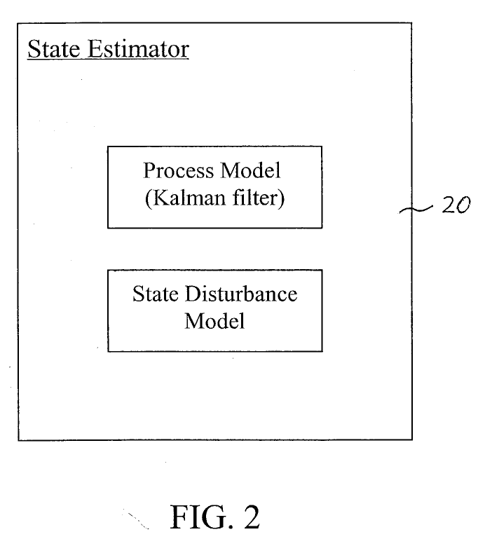

As shown in FIG. 2, the state estimator 20 is configured to employ a process model which effectively describes the relationship between the lithographic steppers 28 and the metrology sensors 22. In ASIC fabrication, each tool-device-layer-reticle combination behaves in a unique way. Therefore, for the controller to be effective, each unique combination must have its own unique model. The state estimator 20 employs a Kalman filter that is configured to automatically estimate uncertain states given metrology measurements. In addition to the process model, the state estimator 20 employs a state disturbance model to remove steady-state offset due to the mismatch between the model prediction and reality. This mismatch or bias can arise from non-zero disturbances in process inputs, states and outputs.

Specifically, as shown in FIG. 3, overlay misalignment vectors (some of which are identified with reference numeral 30) are measured and reported for four features per die 32 and nine die per wafer 34. Thus, the overlay metrology tool reports 72 misalignment vectors, which is comprised of 36 misalignment vectors in the x-dimension and 36 misalignment vectors in they-dimension. In the following equations, “g” stands for “grid” as in grid errors, and “r” stands for “reticle” as in reticle errors. The total misalignment vectors are the summations of the interfield (i.e., grid) errors and the intrafield (i.e., reticle) errors.

Δe^{x}=Δe^{x}_{g}+Δe^{x}ᵣ (1)

Δe^{y}=Δe^{y}_{g}+Δe^{y}ᵣ (2)

Δe^{x} and Δe^{y} are the total misalignment vectors in the x-dimension and y-dimension. Similarly, Δe_{g} and Δeᵣ are the interfield (i.e., grid) and intrafield (i.e., reticle) errors, respectively. The interfield (i.e., grid) misalignment vectors are related fundamentally to translation, scale, and rotation by

Δe^{x}_{g}=Tₓ+Sₓx_{g}−R_{g}y_{g}−Rₙy_{y} (3)

Δe^{y}_{g}=T_{y}+S_{y}y_{g}−R_{g}x_{g} (4)

where Tₓ and T_{y} are grid translations in x-dimension and y-dimension. Sₓ and S_{y} are grid scales. R_{g} is grid rotation and Rₙ is grid non-orthogonal rotation. The parameters x_{g} and y_{g} are grid coordinates with the center of the wafer given as (0, 0).

The intrafield (i.e., reticle) misalignment vectors are related fundamentally to magnification and rotation by

Δe^{x}ᵣ=Mᵣxᵣ−Rᵣyᵣ−Rₐyᵣ+Mₐxᵣ (5)

Δe^{y}ᵣ=Mᵣyᵣ−Rᵣxᵣ−Rₐxᵣ+Mₐyᵣ, (6)

where Mᵣ is reticle magnification and Mₐ is asymmetric magnification. Rᵣ is reticle rotation and Rₐ is asymmetric reticle rotation. The parameters xᵣ and yᵣ are die coordinates with the center of the die given as (0, 0).

The process model described in the previous section can be characterized succinctly in discrete state-space form as

xₖ₊₁=Axₖ+Buₖ=wₖ (7)

yₖ=C^{m}xₖ+vₖ (8)

zₖ=C^{c}xₖ (9)

where w and v are zero-mean Gaussian white noise variables with covariances Q_{w} and Rᵥ. The inputs, states, and outputs are defined as follows:

Inputs u: Wafer translation in x and y, wafer scale in x and y, wafer rotation, wafer non-orthogonality, reticle magnification, asymmetric magnification, reticle rotation, and asymmetric reticle rotation (a 10×1 vector).

States x: Wafer translation in x and y, wafer scale in x and y, wafer rotation, wafer non-orthogonality, reticle magnification, asymmetric magnification, reticle rotation, and asymmetric reticle rotation (a 10×1 vector).

Measured outputs y: Δe^{x} and Δe^{y} for 36 different positions across the wafer (a 72×1 vector).

Controlled outputs z: Δe^{x} and Δe^{y} for 36 different positions across the wafer.

As shown in FIG. 2, a state disturbance model is employed to remove steady-state offset due to the mismatch between the model prediction and reality. This mismatch or bias can arise from nonzero disturbances in process inputs, states, and outputs. A state disturbance model assumes that the error between the output measurement and the model's prediction of the output measurement is due to an integrated disturbance in one or more of the process states. For this work, ten state disturbances are employed. Integrating state disturbances are added to wafer translation in x and y, wafer scale in x and y, wafer rotation, wafer non-orthogonality, reticle magnification, asymmetric magnification, reticle rotation, and asymmetric reticle rotation. The state disturbances are modeled as integrating white noise processes given below as

pₖ₊₁=P^{k}+ξₖ³ (10)

where ξ is a zero-mean Gaussian white noise variable. The disturbance state p is considered to be a continuation of the state vector x. Utilizing the state estimator 20 described above to update pₖ, given an output measurement yₖ will provide offset-free control.

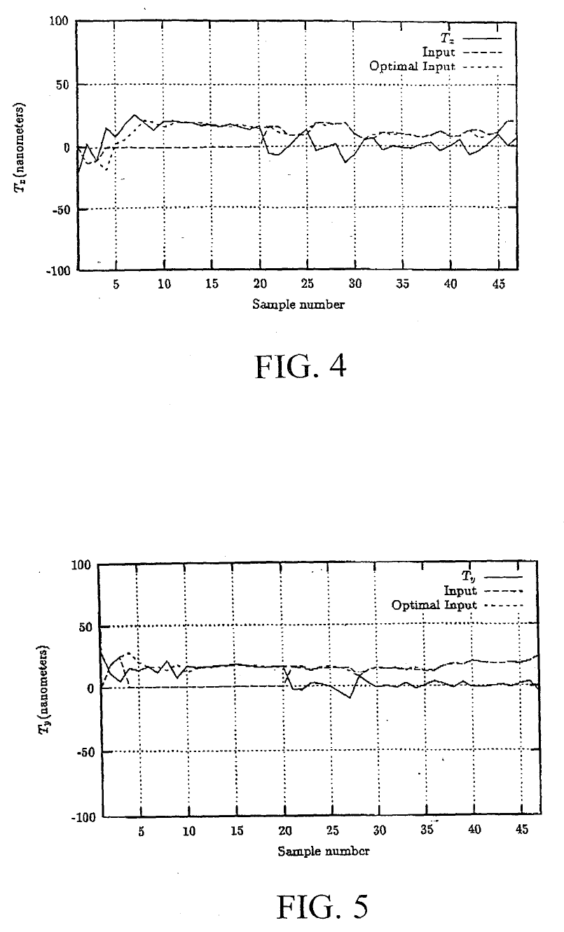

The controller shown in FIG. 1 is configured to perform two separate functions, one of which is estimating the current value of the system states x given an output measurement y. The other function is regulation. It is the task of the state estimator 20 to infer, or reconstruct, the system states by balancing the contribution made by the process model with that given by the measurement. It is the task of the regulator 24 to drive the system states to desired targets 26. A schematic of the estimation and regulation functions of the model-predictive controller used in this work is shown in FIG. 4. At each sample time the regulator takes the optimal state estimate x determined by the estimator 20 and attempts to force the inference z=Cx to track desired targets z^{ref} by varying the system's manipulated variables u. Utilizing the optimal estimate delivered from the state estimator 20 at each sample time as the initial starting point for the regulator 24 incorporates feedback into the controller.

The state estimation problem is defined as finding the most likely value of the state given measured outputs and a dynamic process model. Estimation theory is presented as a problem of updating the conditional probability distribution p(x/y) for the variable x given measurements y. The state variable x is governed by a dynamic differential equation. The outputs y are linear combinations of the states. In systems where all the random variables are normally distributed and the dynamics are linear, the density of the conditional probability distribution is also normal and can be updated according to equations that have the predictor-corrector structure of an observer, known as the Kalman filter. The optimal estimate of the stat, x, is given by

x_{k/k}=x_{k/k-1}+K(y^{m}ₖ−c^{m}x_{k/k-1}) (11)

where x_{k/k-1} and c^{m}x_{k/k-1} are the model predictions from Equations 7 and 8 and yₖ^{m} is the measurement vector. The estimator is tuned by adjustment of the Kalman gain K through the covariance matrix of the measured output, R_{y}.

As previously stated, the feedback controller shown in FIG. 1 performs two separate functions, one of which is estimating the current value of the system states. The other function is regulation. It is the task of the regulator 24 to drive the system states to desired targets. The essence of the regulator 24 is to optimize, over the manipulated inputs u, forecasts of process behavior. The forecasting is accomplished with the process model described above.

The specific control objective for this work is to regulate the overlay process to perfect alignment. Thus, the target vector z^{ref}ₖ is a vector of zeros. The controller performance objective is expressed as the following open-loop quadratic objective function

$${min}_{{u}^{N}} {Φ}_{k} = {\sum }_{j = 0}^{N} ‖ {z}_{k + j}^{ref} - {z}_{k + j ‖ Q}^{2} + ‖ Δ {u}_{k + j ‖ 2 S} , \qquad ( 12 )$$

where the parameters Q and S are the weighting matrices on the outputs and the rate of change of the inputs, respectively and N is the prediction horizon. The controller minimizes the above objective function in discrete time subject to the linear model given in Equations 7 and 9. The solution to the above optimization problem, for basic deadbeat control without input constraints, is just a simple model inversion, given as

uₖ=−((C^{c}B)^{T} (C_{c}B)^{T}C^{c}Ax_{k/k-} (13)

The controller is very effective in rejecting process disturbances such as tool drift and model mismatch. All overlay errors are preferably driven to zero +/− the measurement variance of the metrology tool 22. This level of control is achieved for all tool-device-layer-reticle combinations.

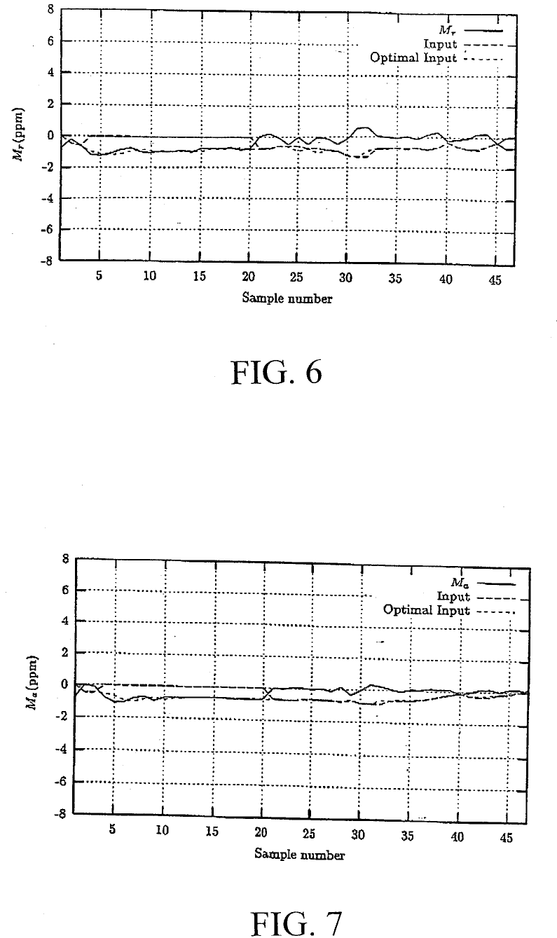

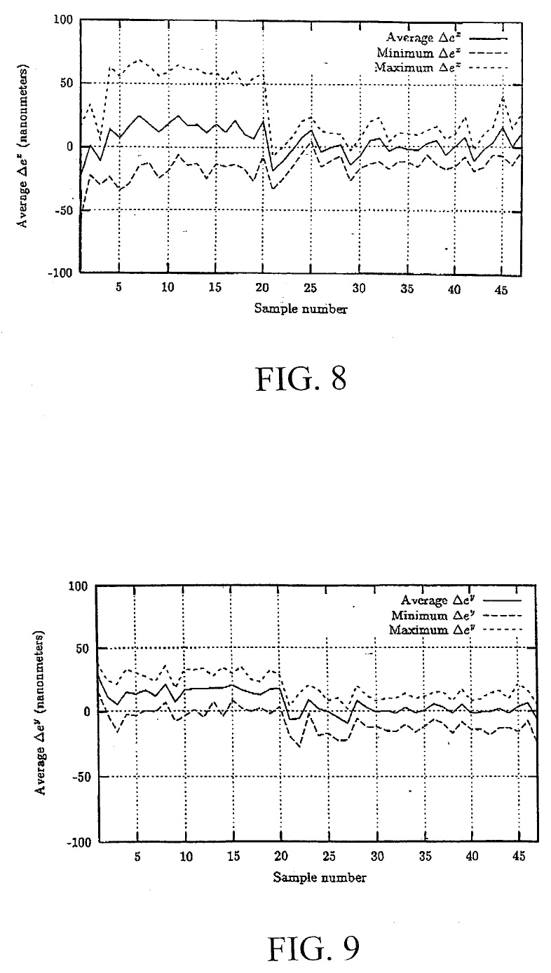

FIGS. 4 through 7 show the inferred states Tₓ, T_{y}, Mᵣ and Mₐ for one unique tool-device-layer-reticle combination. The figures also show the inputs, which are the process corrections applied to the photo-lithography steppers 28, as well as the optimal inputs, which are the inputs that should be applied to the stepper 28 to reject the disturbances. When the input and optimal-input lines converge, the controller is on. The controller was turned on at sample number 21. FIGS. 8 and 9 show the resulting measured overlay errors for this unique tool-device-layer-reticle combination. The controller, which was turned on at sample number 21, drives the average Δe^{x} and Δe^{y} values to zero. FIGS. 8 and 9 also show plots of the largest and smallest misalignment vectors. As the controller turns on, these maximum and minimum overlay errors reduce to the variance of the metrology tool 22 that measured the error. Every deterministic disturbance has been removed by the controller.

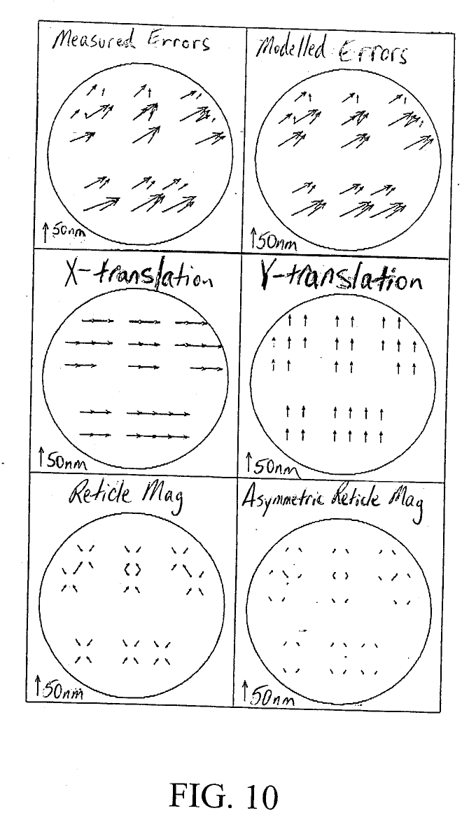

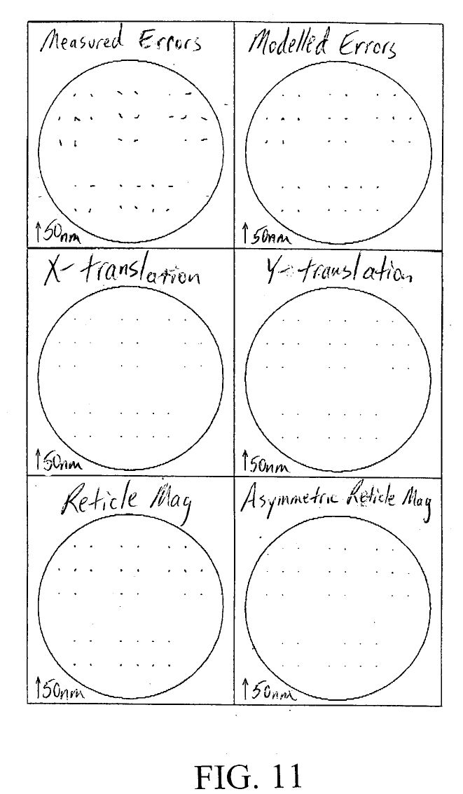

FIGS. 10 through 11 further demonstrate the effectiveness of the controller. FIG. 10 shows the measured overlay errors for a sample that was processed with the controller off. FIG. 10 also shows the modeled errors as well as the inferred states that make up most of these errors. As shown, the estimator 20 is able to accurately model the overlay errors. These errors are deterministic and can be removed by the regulator 24. FIG. 11 shows the measured and modeled overlay errors for a sample that was processed with the controller on. All deterministic disturbances have been removed by the controller and the resulting measured overlay errors reflect the variance of the metrology sensor 22.

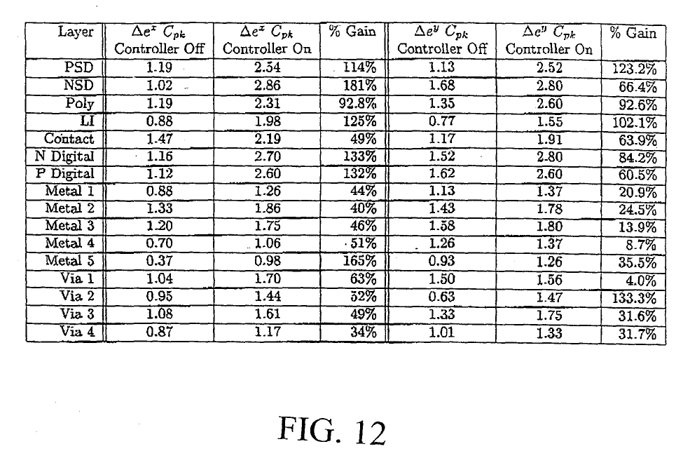

FIG. 12 shows a tabulation of process capabilities for the misalignment vectors Δe^{x} and Δe^{y} calculated over a month when the controller was off and over a month when the controller was on. The capability metric, Cₚₖ, is calculated for each critical layer and includes measurements of all device codes and all photo-lithography steppers 28. As FIG. 12 indicates, the controller provides substantial gains in process capability. The result of this gain in process capability is most noticeable when considering the total rework rate. The controller can reduce the number of reworks attributed to misalignment problems to effectively zero. As the percentage of reworks decreases, total moves through the area may increase. Given the productivity value of the area, it is easy to calculate how the reduction in the rework rate translates to cost savings. Implementation of the controller shown in FIG. 1 can result in estimated savings of approximately $500,000 per month, for example.

The model, method and apparatus (i.e., model-predictive controller) described herein is specifically directed to solve a control problem (i.e., with regard to overlay in ASIC fabrication). The model, method and apparatus can be readily applied to any other process, provided that the process is indeed a linear system.

While an embodiment of the present invention is shown and described, it is envisioned that those skilled in the art may devise various modifications of the present invention without departing from the spirit and scope of the appended claims.

What is claimed is:

1. A model-predictive controller configured to estimate process disturbances from raw overlay registration data, and subsequently regulate the process disturbances.

2. A model-predictive controller as defined in claim 1, wherein the model-predictive controller is configured to estimate values of system states given an output measurement.

3. A model-predictive controller as defined in claim 2, further comprising a state estimator configured to estimate the process disturbances and a regulator configured to regulate the system states to desired targets.

4. A model-predictive controller as defined in claim 2, wherein the model-predictive controller is configured to estimate values of at least one of the following system states: wafer x-translation, wafer y-translation, wafer scale in x, wafer scale in y, wafer rotation, wafer non-orthogonality, reticle magnification, asymmetric magnification, reticle rotation, asymmetric reticle rotation.

5. A model-predictive controller as defined in claim 2, wherein the model-predictive controller is configured to estimate values of all of the following system states: wafer x-translation, wafer y-translation, wafer scale in x, wafer scale in y, wafer rotation, wafer non-orthogonality, reticle magnification, asymmetric magnification, reticle rotation, asymmetric reticle rotation.

6. A model-predictive controller as defined in claim 1, wherein the controller is configured to regulate the process disturbances to zero plus or minus measurement variance of the metrology tool, thereby resulting in precise control of overlay in a ASIC fabrication.

7. A model-predictive controller as defined in claim 6, wherein the controller is configured to drive overlay registration errors for each unique toll-device-layer-reticle combination to zero.

8. A model-predictive controller as defined in claim 1, wherein the controller is configured to employ a state disturbance model to remove steady-state offset.

9. A model-predictive controller as defined in claim 1, wherein the controller maps process corrections to measured outputs.

10. A model-predictive controller as defined in claim 1, wherein the controller is configured to estimate process disturbances based on 72 misalignment vectors received from a metrology tool.

11. A model-predictive controller as defined in claim 10, wherein the controller is configured to estimate process disturbances based on 36 misalignment vectors in one dimension and 36 misalignment vectors in another dimension.

12. A model-predictive controller as defined in claim 10, wherein the misalignment vectors are summations of an interfield.

13. A model-predictive controller as defined in claim 12, wherein the interfield misalignment vectors are related to translation, scale and rotation.

14. A model-predictive controller as defined in claim 10, wherein the misalignment vectors are summations of grid errors and reticle errors.

15. A model-predictive controller as defined in claim 14, wherein the reticle errors are related to magnification and rotation.

16. A model-predictive controller as defined in claim 10, wherein the misalignment vectors are summations of reticle errors.

17. A method of controlling overlay in ASIC fabrication, said method comprising estimating process disturbances from raw overlay registration data, and regulating the process disturbances to control overlay.

18. A method as defined in claim 17, further comprising estimating values of system states given an output measurement.

19. A method as defined in claim 18, further comprising using a state estimator to estimate the process disturbances and using a regulator configured to regulate the system states to desired targets.

20. A method as defined in claim 18, further comprising estimating values of at least one of the following system states: wafer x-translation, wafer y-translation, wafer scale in x, wafer scale in y, wafer rotation, wafer non-orthogonality, reticle magnification, asymmetric magnification, reticle rotation, asymmetric reticle rotation.

21. A method as defined in claim 18, further comprising estimating values of all of the following system states: wafer x-translation, wafer y-translation, wafer scale in x, wafer scale in y, wafer rotation, wafer non-orthogonality, reticle magnification, asymmetric magnification, reticle rotation, asymmetric reticle rotation.

22. A method as defined in claim 18, further comprising regulating the process disturbances to zero plus or minus measurement variance of the metrology tool.

23. A method as defined in claim 22, further comprising driving overlay registration errors for each unique toll-device-layer-reticle combination to zero.

24. A method as defined in claim 18, further comprising employing a state disturbance model to remove steady-state offset.

25. A method as defined in claim 18, further comprising mapping process corrections to measured outputs.

26. A method as defined in claim 18, further comprising estimating process disturbances based on 72 misalignment vectors received from the metrology tool.

27. A method as defined in claim 18, further comprising estimating process disturbances based on 36 misalignment vectors in one dimension and 36 misalignment vectors in another dimension.

28. A method as defined in claim 26, wherein the misalignment vectors are summations of an interfield.

29. A method as defined in claim 28, wherein the interfield misalignment vectors are related to translation, scale and rotation.

30. A method as defined in claim 26, wherein the misalignment vectors are summations of grid errors and reticle errors.

31. A method as defined in claim 30, wherein the reticle errors are related to magnification and rotation.

32. A method as defined in claim 26, wherein the misalignment vectors are summations of reticle errors.
